(19) United States
(12) Patent Application Publication
(10) Pub. No.: US 2009/0254237 A1
(43) Pub. Date: Oct. 8, 2009

(54) Apparatus for failure diagnosis of a vehicular foot brake switch

(76) Inventors: Hideyuki Takahashi, Kawasaki (JP); Tadao Kobayashi, Kawasaki-shi (JP); Koji Oguchi, Kawasaki (JP); Yoshiaki Moroguchi, Kawasaki (JP)

Correspondence Address: JACOBSON HOLMAN PLLC, 400 SEVENTH STREET N.W., SUITE 600, WASHINGTON, DC, 20004, US

(21) Appl. No.: 12/149,466

(22) Filed: May 1, 2008

(30) Foreign Application Priority Data
May 1, 2007 (JP) 2007-120682

(51) Int. Cl. G06F 7/00

(52) U.S. Cl. 701/29

(57) ABSTRACT

An apparatus for failure diagnosis starts counting a frequency of a switching action of a foot brake switch when determining that vehicle speed is higher than a first criterion value, and ceases to count the frequency of the switching action when determining that the vehicle speed has decreased below a second criterion value set to be lower than the first criterion value. When the frequency of the switching action counted by a count section is less than a predetermined value, the apparatus for failure diagnosis determines that the foot brake switch has a failure.

### BACKGROUND OF THE INVENTION

1. Field of the Invention

This invention relates to an apparatus for failure diagnosis of a vehicular foot brake switch.

2. Description of the Related Art

A foot brake switch detecting an operation state of a foot brake for a vehicle is not only used to put on a brake lamp, recently, it is also used in control over various types of exhaust purification devices. For example, forced regeneration, which is one type of control performed to restore the function of a DPF (diesel particulate filter) by burning off PM (particulate matter) accumulated in the DPF, can be performed, as long as the vehicle is parked with the foot brake in the “OFF” state (deactivated) and the parking brake in the “ON” state (activated).

Such exhaust purification device not exhibiting the intended exhaust purification performance immediately leads to the emission of harmful substances into the atmosphere. Thus, for example in North America, legal regulations concerning the OBD (on-board diagnosis) require that vehicles be equipped with an apparatus for failure diagnosis capable of detecting failure of the foot brake switch, storing information detected, and presenting a failure indication to urge the drive to repair. In order to comply with such legal regulations, etc., there have been proposed apparatuses for failure diagnosis for diagnosing failure of the foot brake switch, one of which is disclosed in Japanese Unexamined Patent Publication 2003-182557 (hereinafter referred to as Patent Document 1), for example.

The apparatus for failure diagnosis disclosed in Patent Document 1 includes an auxiliary switch designed to come into the “ON” state in advance of turn-on operation of a main switch (foot brake switch in its proper sense) following the depression of a brake pedal, where the apparatus for failure diagnosis determines that the main switch has a failure, when the number of times that the main switch fails to come into the “ON” state within a predetermined period of time after the auxiliary switch coming into the “ON” state exceeds a predetermined threshold value.

In the apparatus for failure diagnosis disclosed in Patent Document 1, the auxiliary switch is disposed near the main switch, so that both switches are influenced by the surrounding environment in a similar way. Further, since both switches are based on the same principle of detecting a pedal operation through electric contacts being connected or disconnected, there is a possibility that both switches fail simultaneously, in which case failure detection is impossible. Thus, there is room for improvement in reliability of failure detection.

Failures of the main switch include not only being fixed in the “OFF” state (hereinafter referred to as “OFF” fixedness), but also being fixed in the “ON” state (hereinafter referred to as “ON” fixedness), noise-related failure, and incomplete disconnection. The apparatus for failure diagnosis disclosed in Patent Document 1 can, however, not detect the failure of the main switch when the main switch has a failure other than the “OFF” fixedness. Thus, there is also room for improvement in failure detection function.

### SUMMARY OF THE INVENTION

An aspect of the present invention is directed to an apparatus for failure diagnosis of a vehicular foot brake switch, comprising; driving state detection means for detecting driving state of a vehicle; count means adapted to start counting a frequency of a switching action of the foot brake switch when determining that vehicle speed of the vehicle exceeds a first criterion value, on the basis of the driving state of the vehicle detected by the driving state detection means, and cease to count the frequency of the switching action when determining that the vehicle speed of the vehicle has decreased below a second criterion value set to be lower than the first criterion value; and failure determination means adapted to determine that the foot brake switch has a failure when the frequency of the switching action of the foot brake switch counted by the count means is less than a predetermined value.

Alternatively, an aspect of the present invention is directed to an apparatus for failure diagnosis of a vehicular foot brake switch, comprising; failure determination means adapted to monitor a switching action of the foot brake switch, and determine that the foot brake switch has a failure when the foot brake switch repeats the switching action at such short intervals that a driver cannot repeat operation.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is an overall structural view showing an apparatus for failure diagnosis of an automotive foot brake switch according to one embodiment of the present invention;

FIG. 2 is a flow chart showing a failure diagnosis routine executed by an ECU of the apparatus for failure diagnosis shown in FIG. 1;

FIG. 3 is a flow chart showing a fixedness count routine executed by the ECU of the apparatus for failure diagnosis shown in FIG. 1; and

FIG. 4 is a flow chart showing a noise/incomplete disconnection count routine executed by the ECU of the apparatus for failure diagnosis shown in FIG. 1.

### DETAILED DESCRIPTION OF THE INVENTION

Referring to the accompanying drawings, an apparatus for failure diagnosis of a vehicular foot brake switch according to one embodiment of the present invention will be described in detail.

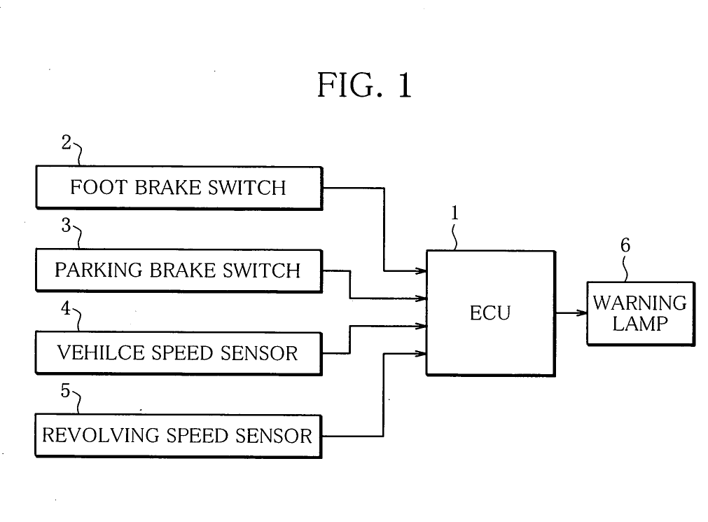

FIG. 1 is an overall structural view showing an apparatus for failure diagnosis of a vehicular foot brake switch according to the embodiment.

An ECU (electronic control unit) 1 which performs failure diagnosis concerning a foot brake switch 2 of a vehicle is installed in a passenger compartment, and comprises input/output devices, memory units (ROM, RAM, BURAM, etc.) storing a large number of control programs, a central processing unit (CPU), timer counters, etc., which are not shown.

To the input of the ECU 1, various sensors, such as a parking brake switch 3, a vehicle speed sensor (driving state detection means/vehicle speed detection means) 4, a revolving speed sensor (driving state detection means/revolving speed detection means) 5, are connected, in addition to a foot brake switch 2 for detecting an operation state of a foot brake pedal of the vehicle. The parking brake switch 3 detects an operation state of a parking brake lever disposed in the passenger compartment. The vehicle speed sensor 4 detects vehicle speed V, while the revolving speed sensor 5 detects engine revolving speed Ne. To the output of the ECU 1, a warning lamp 6 disposed near a driver's seat, etc. are connected.

The foot brake switch 2 is disposed near the foot brake pedal, while the parking brake switch 3 is disposed near the parking brake lever. The foot brake switch 2 and the parking brake switch 3 come into the “ON” state, when the brake pedal and the parking brake lever are activated, respectively, and come into the “OFF” state, when they are deactivated, respectively.

In the present embodiment, the vehicle is equipped with a diesel engine, and the exhaust system of the engine includes a DPF (diesel particulate filter) for trapping particulate matter contained in exhaust gases. Both the diesel engine and the DPF are not shown in the drawings. In this type of DPF, PM trapped by the DPF is burned off occasionally during normal traveling (automatic regeneration), where the ECU 1 monitors the amount of PM accumulated in the DPF, calculated from the amount of PM trapped and the amount of PM burned off in regeneration. When the PM accumulation quantity exceeds a specific standard, the ECU 1 gives a warning, in response to which the driver parks the vehicle and starts forced regeneration (by putting a forced regeneration start switch into the “ON” state, for example). Such forced regeneration is performed, as long as the predetermined parking conditions, namely the foot brake being deactivated and the parking brake being activated, are satisfied, and the foot brake switch 2 is used in determining whether or not these parking conditions are satisfied.

Erroneous determination concerning the parking conditions due to failure of the foot brake switch 2 leads to inappropriate judgment of the propriety of execution of forced regeneration. This results in unsuccessful regeneration of the DPF to cause breakdown or melting of the DPF, therefore leads to the problem that the emission of particulate matter into the atmosphere cannot be properly suppressed. Thus, in the present embodiment, the ECU 1 of the vehicle performs failure diagnosis concerning the foot brake switch 2, which will be described below in detail.

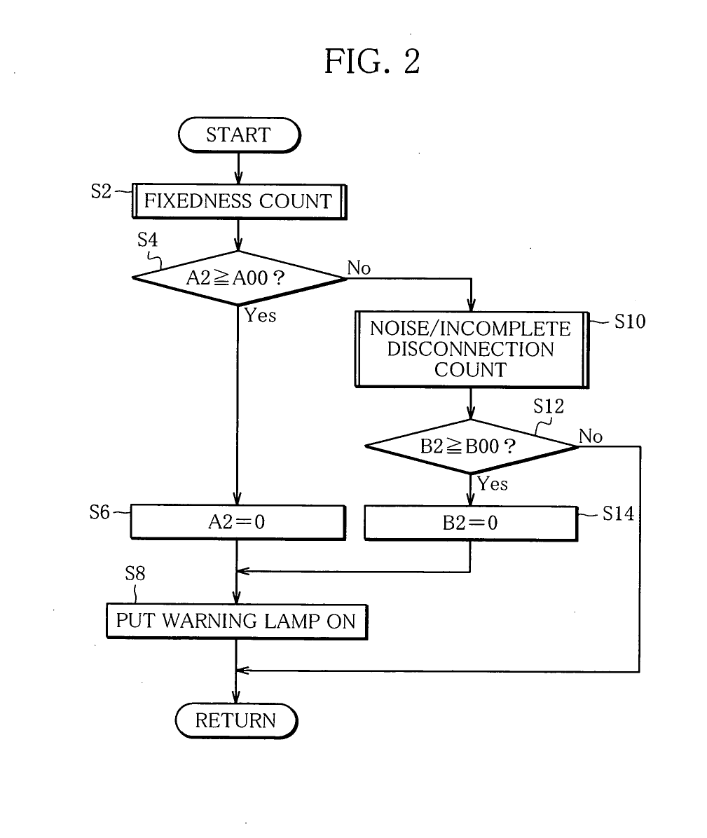

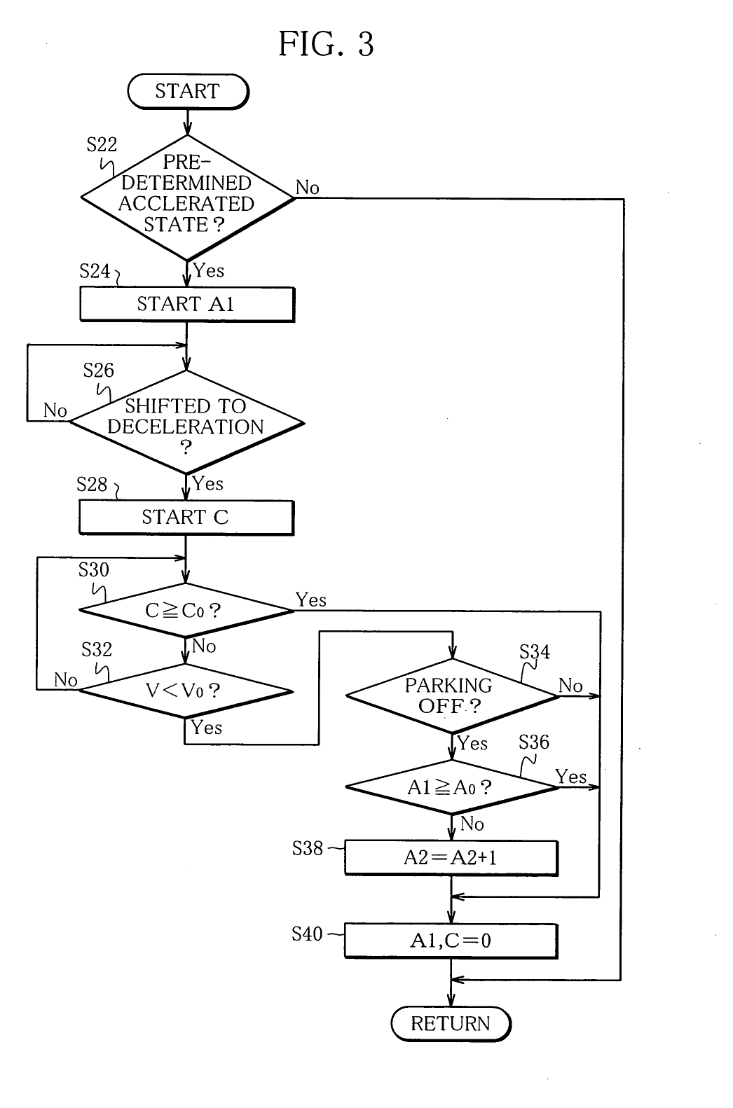

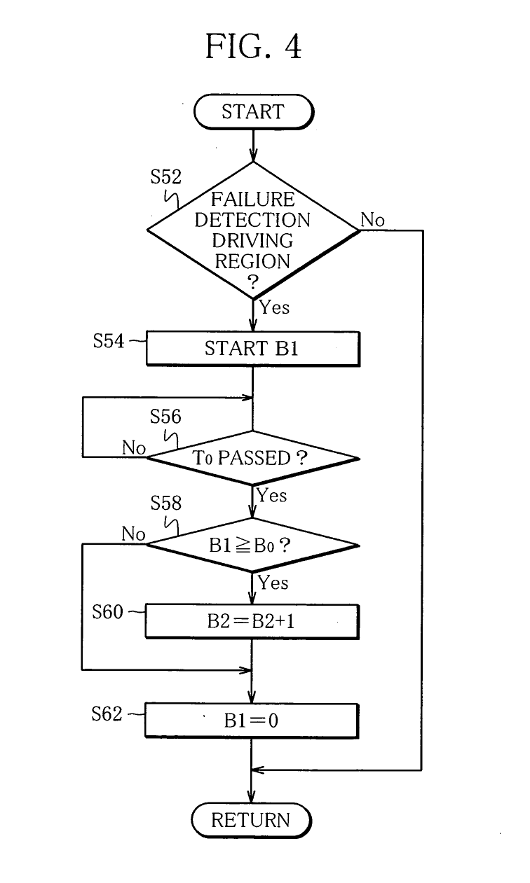

FIG. 2 is a flow chart showing a failure diagnosis routine executed by the ECU 1, FIG. 3 a flow chart showing a fixedness count routine executed by the ECU 1, and FIG. 4 a flow chart showing a noise/incomplete disconnection count routine executed by the ECU 1.

The ECU 1 executes the failure diagnosis routine shown in FIG. 2 at predetermined control intervals. First, in Step S2, the ECU 1 executes the fixedness count routine. When the ECU 1 starts the fixedness count routine, the ECU 1 shifts the procedure to Step S22 in FIG. 3, where the ECU 1 determines whether or not the vehicle has reached a predetermined accelerated state. Specifically, the following three requirements 1) to 3) are set for determination concerning the accelerated state:

1) Vehicle speed V>50 km/h
2) Engine revolving speed Ne>2000 rpm
3) Target injection quantity Q set in fuel injection control>50 mg/cycle

The ECU 1 monitors the target fuel injection quantity for the engine, in addition to the output of the vehicle speed sensor 4 and the revolving speed sensor 5 (driving state detection means/target fuel injection quantity detection means), and when these three requirements are all met simultaneously, the ECU 1 determines “Yes” in Step S22.

Specifically, these requirements are set to determine that the vehicle has been accelerated to a driving state at a certain level of vehicle speed V (>50 km/h), or in other words, reached a traveling state having room for deceleration. From the fact that these requirements are met, it can be inferred that the foot brake will be operated to stop the vehicle at some future time. The setting of the requirements for determination in Step S22 is not restricted to this. For example, the ECU 1 may make a determination concerning the accelerated state, only on the basis of requirement 1) related to the vehicle speed.

When the determination in Step S22 is “No”, the ECU 1 finishes the fixedness count routine, once. When the determination in Step S22 is “Yes”, the ECU 1 advances the procedure to next Step S24 and starts a counter A1 (count means). The counter A1 counts how many times the switching action of the foot brake switch 2 is made. Each time the foot brake switch 2 shifts from the “OFF” state to the “ON” state or vice versa following the driver's foot brake operation, the counter increases in value.

In next step S26, the ECU 1 determines whether or not the vehicle has shifted to deceleration. Specifically, if any of the above-mentioned three requirements is no longer met, which means that the vehicle speed or the engine revolving speed has decreased and the vehicle has actually shifted to deceleration, or that the target fuel injection quantity Q has decreased and the vehicle is expected to shift to deceleration immediately, the determination in Step S26 is “Yes”.

Then in Step S28, the ECU 1 starts a deceleration counter C. The counter C is adapted to increase in value at predetermined intervals, so that the counter value correlates with time elapsed after the deceleration starts. Then in Step S30, the ECU 1 determines whether or not the value of the counter C has reached a predetermined value CO (value corresponding to 10 sec, for example), and in next Step S32, the ECU 1 determines whether or not the vehicle speed V has decreased to or below a predetermined stop criterion value V0 (2 km/h, for example).

The conditions referred to for making determination in Steps S30 and S22 are set to distinguish between relatively gentle deceleration by an engine brake and relatively steep deceleration by the foot brake. If the ECU 1 determines “Yes” in Step S30 before determining “Yes” in Step S32, the present deceleration is considered as relatively gentle deceleration by the engine brake, and the ECU 1 advances the procedure to Step S40. In Step S40, the ECU 1 resets the counter A1 and the counter C, and the ECU 1 finishes the routine. If the ECU 1 determines “Yes” in Step S32 before determining “Yes” in Step S30, the present deceleration is considered as relatively steep deceleration with the foot brake, and the ECU 1 advances the procedure to Step S34.

In Step S34, the ECU 1 determines whether or not predetermined time (3 sec, for example) has passed with the parking brake switch 3 kept in the “OFF” state. If the determination in Step S34 is “No”, namely there is a possibility that the present deceleration have been performed with the parking brake, the ECU 1 advances the procedure to Step S40. If the determination in Step S34 is “Yes”, namely it is considered that the parking brake has not been involved in the present deceleration, the ECU 1 advances the procedure to Step S36 and determines whether or not the value of the counter A1 is greater than or equal to a predetermined value A0. For the value A0, the number of times that the foot brake is generally considered to be operated at the minimum, while the vehicle is accelerated and then decelerated to stop, for example “1” is set.

If the determination in Step S36 is “Yes”, the ECU 1 advances the procedure to Step S40. If the determination in Step S36 is “No”, the ECU 1 advances the procedure to Step S38, increments the counter A2 by 1, and then advances the procedure to Step S40.

Since deceleration by the engine brake or the parking brake is excluded by the processing in Steps S30 to S34, the determination in Step S36 is made on the assumption that the vehicle has been decelerated with the foot brake. Thus, the counter A2 is incremented by 1, each time the ECU 1 determines “No” in Step S36 although the foot brake has been operated. Consequently, the value of the counter A2 represents how many times the determination that the foot brake switch 2 is fixed (regardless of whether it is “ON” fixedness or “OFF” fixedness) has been made.

After finishing the fixedness count routine, the ECU 1 shifts the procedure to Step S4 in FIG. 2. In Step S4, the ECU 1 determines whether or not the value of the counter A2 has reached a failure criterion value A00 (3, for example). If the determination in Step S4 is “Yes”, the ECU 1 makes the final determination that the foot brake switch 2 is fixed (failure determination means), and the ECU 1 puts on a warning lamp 6 in Step S8 after resetting the counter A2 in Step S6. The ECU 1 finishes the routine after the processing of Step S8.

If the determination in Step S4 is “No”, the ECU 1 advances the procedure to Step S10 and executes a noise/incomplete disconnection count routine. When the ECU 1 starts the noise/incomplete disconnection count routine, the ECU 1 shifts the procedure to Step S52 in FIG. 4, where the ECU 1 determines whether or not the driving state of the vehicle is in a predetermined failure-detection driving region. Specifically, the following two requirements 4) and 5) are set for determination concerning the failure-detection driving region, and when either of these requirements is met, the ECU 1 determines “Yes” in Step S52:

4) Engine is operating
5) Vehicle speed V>predetermined value V0 km/h

Requirement 4) implies that noise can be produced from the operating engine. When requirement 4) is met, if the foot brake switch 2 has some malfunction or is deteriorated, the foot brake switch 2 may shift between the “ON” state and the “OFF” state in synchronization with noise. Requirement 5) implies that vibration can be generated while the vehicle is traveling. When requirement 5) is met, if the foot brake switch 2 has incomplete disconnection (state that the switch is liable to repeat making and breaking contact under slight vibration, in a manner not completely breaking a signal line), the foot brake switch 2 may shift between the “ON” state and the “OFF” state in synchronization with vibration. In either case, the ON/OFF action of the foot brake switch 2 arising from its malfunction, deterioration or incomplete disconnection repeats itself at such short intervals that the normal ON/OFF action caused by the driver's foot brake operation cannot have.

If the determination in Step S52 is “No”, the ECU 1 finishes the routine after the determination in Step S52. If the determination in Step S52 is “Yes”, the ECU 1 advances the procedure to Step S54 and starts a counter B1. Like the counter A1, the counter B1 counts how many times the switching action of the foot brake switch 2 is made. Each time the foot brake switch 2 shifts from the “OFF” state to the “ON” state or vice versa following the driver's foot brake operation, the counter increases in value.

In next Step S56, the ECU 1 determines whether or not predetermined measurement time T0 (2 sec, for example) has passed. If the predetermined measurement time T0 has passed, and therefore the determination in Step S56 is “Yes”, the ECU advances the procedure to Step S58 and determines whether or not the value of the counter B1 is greater than or equal to a predetermined value B0. For the value B0, so great a value (8, for example) that could not apply to the normal action of the foot brake switch 2 caused by the driver's operation is set, taking account of the measurement time T0. Thus, when the value of the counter B1 is greater than or equal to the predetermined value B0, it may be considered that the foot brake switch 2 has repeated the switching action due to noise or incomplete disconnection.

If the determination in Step S58 is “No”, the ECU 1 advances the procedure to Step S62 in which the ECU 1 resets the counter B1, and the ECU 1 finishes the routine. If the determination in Step S58 is “Yes”, the ECU 1 advances the procedure to Step S60 to increment the counter B2 by 1, and then advances the procedure to Step S62. Thus, the counter B2 is incremented by 1, each time the ECU 1 determines “Yes” in Step S58, namely determines that the foot brake switch 2 has repeated the switching action due to noise or incomplete disconnection. Consequently, the value of the counter B2 represents how many times the determination that the foot brake switch 2 is influenced by noise or incomplete disconnection has been made.

After finishing the noise/incomplete disconnection count routine, the ECU 1 shifts the procedure to Step S12 in FIG. 2. In Step S12, the ECU 1 determines whether or not the value of the counter B2 has reached a failure criterion value B00 (3, for example). If the determination in Step S12 is “Yes”, the ECU 1 makes the final determination that the foot brake switch 2 is influenced by noise or has incomplete disconnection (failure determination means), and the ECU 1 puts on the warning lamp 6 in Step S8 after resetting the counter B2 in Step S14. The ECU 1 finishes the routine after the processing of Step S8.

According to the above-described processing of the ECU 1, when the foot brake switch 2 has “ON” fixedness or “OFF” fixedness, each time the vehicle is accelerated and then decelerated to stop, the counter A2 is incremented following the determination in Step S36. When the value of the counter A2 reaches the failure criterion value A00, the ECU 1 determines that the foot brake switch 2 has a failure. Further, when the foot brake switch 2 is malfunctioning due to noise or has incomplete disconnection, the counter B2 is incremented following the determination in Step S58 which is made while the driving state of the vehicle is in the failure-detection traveling region. When the value of the counter B2 reaches the failure criterion value B00, the ECU 1 determines that the foot brake switch 2 has a failure. In either case, after determining that the foot brake switch 2 has a failure, the ECU 1 puts on the warning lamp 6 to urge the driver to repair.

By this, for example, when it is determined whether or not the vehicle has stopped based on the foot brake switch 2, erroneous determination can be prevented, so that damage such as breakdown or melting of the DPF, arising from inappropriate judgment of the propriety of execution of forced regeneration, which is made on the basis of the erroneous determination, can be prevented. Consequently, the problem that the emission of particulate matter into the atmosphere cannot be suppressed due to the damage such as breakdown or melting of the DPF can be prevented.

As described above, in the apparatus for failure diagnosis of the foot brake switch 2 according to the present embodiment, if the number of times that the switching action of the foot brake switch 2 has been made during the vehicle deceleration has not reached the predetermined value A0 that is the commonly-assumed minimum number of times, which means that the driving state of the vehicle and the action of the foot brake switch 2 are inconsistent, the ECU 1 determines that the foot brake switch 2 has a failure, considering that the foot brake switch 2 is fixed. Further, if the foot bake switch 2 repeats the switching action at such short intervals that the normal switching action caused by the driver's foot brake operation cannot have, the ECU 1 determines that the foot brake switch 2 has a failure, considering that the foot brake switch 2 is influenced by noise or incomplete disconnection.

Thus, with respect to any type of failure, the ECU 1 determines that the foot brake switch 2 has a failure when the foot brake switch 2 has exhibited an abnormal switching action deviating from a standard switching action of the foot brake switch 2 which is assumed according to common sense. This principle of failure detection is completely different from the principle of the technique using an auxiliary switch, disclosed in Patent Document 1, for example, and can avoid the problems of the technique of Patent Document 1 such as low reliability, which arise from the feature that failure is detected on the basis of an auxiliary switch similar to the main switch. Thus, the apparatus for failure diagnosis according to the present embodiment can detect failure of the foot brake switch 2 with high reliability.

The above-mentioned principle is useful in detecting of the fixedness of the foot brake switch 2, not only “OFF” fixedness but also “ON” fixedness, and also the failure of the foot brake switch 2 due to noise or incomplete disconnection. Thus, the apparatus for failure diagnosis according to the present embodiment can deal with various types of failure of the foot brake switch 2, therefore, is greatly improved in diagnosis function.

Further, since deceleration by the engine brake or the parking brake is excluded by the processing in Steps 30 to 34, the problem that failure determination made during the deceleration performed in such manner produces an erroneous result is prevented. This leads to a further improvement in reliability of failure detection.

Further, the processing of Step S52 ensures that failure determination is performed only when the driving state of the vehicle is in the failure-detection driving region in which the foot brake switch 2 may be influenced by noise or incomplete disconnection. This feature also contribute to prevent an erroneous determination and can further improve reliability of failure detection.

In the above, one embodiment has been described. The present invention is, however, not restricted to the described embodiment. For example, although in the described embodiment, the ECU 1 detects fixedness failure and failure due to noise or incomplete disconnection of the foot brake switch 2, the apparatus for the failure diagnosis does not absolutely need to detect both types of failure; it may detect either type.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for failure diagnosis of a vehicular foot brake switch, comprising:
driving state detection means for detecting driving state of a vehicle;
count means adapted to start counting a frequency of a switching action of the foot brake switch when determining that vehicle speed of the vehicle exceeds a first criterion value, on the basis of the driving state of the vehicle detected by the driving state detection means, and cease to count the frequency of the switching action when determining that the vehicle speed of the vehicle has decreased below a second criterion value set to be lower than the first criterion value; and
failure determination means adapted to determine that the foot brake switch has a failure when the frequency of the switching action of the foot brake switch counted by the count means is less than a predetermined value.

2. The apparatus for failure diagnosis of the vehicular foot brake switch according to claim 1, wherein
the driving state detection means is a vehicle speed detection means for detecting vehicle speed.

3. The apparatus for failure diagnosis of the vehicular foot brake switch according to claim 1, wherein
the driving state detection means comprises:
vehicle speed detection means for detecting vehicle speed;
revolving speed detection means for detecting engine revolving speed of an engine mounted on the vehicle; and
target fuel injection quantity detection means for detecting target fuel injection quantity for the engine, wherein
when the vehicle speed detected by the vehicle speed detection means is higher than a predetermine vehicle speed and the engine revolving speed detected by the revolving speed detection means is higher than a predetermined revolving speed and the target fuel injection quantity detected by the target fuel injection quantity detection means is greater than a predetermined quantity, the count means determines that the vehicle speed of the vehicle is higher than the first criterion value and starts counting the frequency of the switching action.

4. The apparatus for failure diagnosis of the vehicular foot brake switch according to claim 3, wherein
when the vehicle speed detected by the vehicle speed detection means has decreased below the second criterion value, the count means ceases to count the frequency of the switching action.

5. The apparatus for failure diagnosis of the vehicular foot brake switch according to claim 1, wherein
the failure determination means makes determination concerning failure of the foot brake switch, excluding deceleration by an engine brake.

6. The apparatus for failure diagnosis of the vehicular foot brake switch according to claim 5, wherein
the failure determination means determines that the vehicle has been decelerated by the engine brake when time elapsed after the vehicle started deceleration reaches predetermined time before the vehicle speed decreases to a predetermined vehicle speed.

7. The apparatus for failure diagnosis of the vehicular foot brake switch according to claim 1, wherein
the failure determination means makes determination concerning failure of the foot brake switch, excluding deceleration by a parking brake.

8. The apparatus for failure diagnosis of the vehicular foot brake switch according to claim 1, wherein
the failure determination means determines that the foot brake switch has a failure also when the foot brake switch repeats a switching action at such short intervals that a driver cannot repeat operation.

9. An apparatus for failure diagnosis of a vehicular foot brake switch, comprising:
failure determination means adapted to monitor a switching action of the foot brake switch, and determine that the foot brake switch has a failure when the foot brake switch repeats the switching action at such short intervals that a driver cannot repeat operation.

10. The apparatus for failure diagnosis of the vehicular foot brake switch according to claim 9, wherein,
the failure determination means determines whether or not the foot brake switch has a failure while the vehicle is traveling at a vehicle speed higher than a predetermine vehicle speed.

11. The apparatus for failure diagnosis of the vehicular foot brake switch according to claim 10, wherein,
the failure determination means determines whether or not the foot brake switch has a failure also while an engine mounted on the vehicle is operating.
